(19) United States
(12) Patent Application Publication
(10) Pub. No.: US 2013/0093284 A1
(43) Pub. Date: Apr. 18, 2013

(54) ROTOR OF ELECTRIC ROTATING MACHINE

(71) Applicant: Ryosuke Utaka, Takahama-shi (JP)

(72) Inventor: Ryosuke Utaka, Takahama-shi (JP)

(73) Assignee: DENSO CORPORATION, Kariya-city, Aichi-pref (JP)

(21) Appl. No.: 13/697,477

(22) PCT Filed: May 12, 2011
(86) PCT No.: PCT/JP2011/060931

§ 371 Date: Jan. 8, 2013

(30) Foreign Application Priority Data
May 13, 2010 (JP) 2010-111428
Apr. 28, 2011 (JP) 2011-101908

(51) Int. Cl. H02K 1/27

(52) U.S. Cl. CPC H02K 1/2773
USPC 310/216.094

(57) ABSTRACT

The waveform of a magnetomotive force generated by a rotor is comprised of a plurality of sections that respectively correspond to a plurality of magnetic poles of the rotor. When viewed along the axial direction of a rotor core, each of the sections of the waveform includes two oblique lines and a connection line. Each of the oblique lines extends from a 0 reference line, which is defined by an outer peripheral surface of the rotor core, obliquely with respect to a radial direction of the rotor core. The connection line connects the two oblique lines in the circumferential direction of the rotor core. Moreover, representing the circumferential width of the connection line by 2π·Duty, the circumferential width of the oblique lines by 2π·Slope, the radial height of the oblique lines by B, the order of a harmonic component of the magnetomotive force by n, and the amplitude of the nth harmonic component by Amp₁, then the following relationship is satisfied: Slope=k/n (here, k is an arbitrary natural number). The amplitude of the nth harmonic component is determined by: Amp₁ (n)=(4B/nπ)×{sin (nπ·Slope)/nπ·Slope}×sin {nπ(Duty+Slope)} . . . Equation (1).

### TECHNICAL FIELD

The present invention relates to rotors of electric rotating machines such as electric motors and electric generators used in motor vehicles.

### BACKGROUND ART

As shown in FIG. 11, a conventional automotive motor 10 includes a rotating shaft 11, a rotor 14 and a stator 18. The rotor 14 includes an annular rotor core 12 and a plurality of permanent magnets 13. The rotor core 12 is formed by laminating a plurality of annular steel sheets in the axial direction of rotation, and fixed to an outer periphery of the rotating shaft 11. Moreover, in the rotor core 12, there are formed a plurality of through-holes 12a that axially penetrate the rotor core 12 and are arranged in a circumferential direction of the rotor core 12 at predetermined intervals. The permanent magnets 13 are respectively held in corresponding ones of the through-holes 12a of the rotor core 12. The stator 18 includes an annular stator core 17 and a stator coil 16. The stator core 17 has a plurality of slots (not shown) formed in its radially-inner peripheral surface along its circumferential direction. The stator core 17 is coaxially disposed with respect to an outer peripheral surface of the rotor core 12 with a predetermined clearance provided therebetween. The stator coil 16 is wound on the stator core 17.

FIG. 12 shows, of the annular rotor 14 that is divided in its circumferential direction into a plurality of segments, two adjacent rotor core segments 14-1 and 14-2 that respectively correspond to two magnetic poles. As shown in FIG. 12, the permanent magnets 13-1 and 13-2 are embedded in the through-holes 12a that are provided in the vicinity of the outer periphery of the rotor core 12. In the example shown in FIG. 12, when viewed along the axial direction of the rotor core 12, in the left-side rotor core segment 14-1 which corresponds to one magnetic pole, a pair of the permanent magnets 13-1 are symmetrically arranged with respective to a radial centerline L1 of the rotor core segment 14-1 so as to be opposed to each other at predetermined oblique angles to the radial centerline L1. The pair of the permanent magnets 13-1 is arranged so as to be opposite in polarity to a pair of the permanent magnets 13-2 embedded in the right-side rotor core segment 14-2. For example, the pair of the permanent magnets 13-1 is arranged so as to be N on the radially outer side and S on the radially inner side; the adjacent pair of the permanent magnets 13-2 is arranged so as to be S on the radially outer side and N on the radially inner side. A motor including this type of rotor is disclosed, for example, in Patent Document 1.

### PRIOR ART DOCUMENT

### Patent Document

[PATENT DOCUMENT 1] Japanese Unexamined Patent Application Publication No. 2001-54271

### SUMMARY OF THE INVENTION

### Problems to be Solved by the Invention

In the above-described rotor 14 of the conventional motor 10, the waveform of a magnetomotive force generated by the rotor core segments has, as indicated with dashed lines Amp in FIG. 13, such a wave shape as to protrude radially outward in the shape of a trapezoid at portions of the permanent magnets 13-1 while being recessed radially inward in the shape of a trapezoid at portions of the adjacent permanent magnets 13-2 with the outer peripheral surface of the rotor 14 being a 0 reference line. Assuming an ideal case of including only the first component of the magnetomotive force which can be taken out as torque of the motor, the waveform Amp of the magnetomotive force is in the form of a sine wave between the pairs of the permanent magnets 13 which are adjacent to one another at given intervals therebetween.

However, in reality, as shown in FIG. 14(a), when the waveform Amp of the magnetomotive force is outlined in the range of electrical angle from 0 to 360 degrees, the amplitude (being a relative value and thus dimensionless) at the position of 90 degrees (π/2) is in opposite phase to that at the position of 270 degrees (3π/2). Moreover, as shown in FIG. 14(b), the magnetomotive force includes, in addition to the first component whose amplitude is highest, the third-, the fifth, . . . , and the nineteenth harmonic components whose amplitudes are gradually decreased in comparison with the first component. As a result, the waveform Amp of the magnetomotive force becomes trapezoidal in shape as shown in FIG. 15.

Furthermore, in the waveform Amp of the magnetomotive force, as shown in FIG. 15, a connection line, whose height from the 0 reference line is equal to B, has a width of 2π·Duty with its center at the electrical angle of π/2 (=90 degrees); oblique lines, which obliquely extend respectively from ends of the connection line to the 0 reference line, have a width of 2π·Slope. The dimensions of portions in the rotor core segment 14-1 which correspond to those of the waveform Amp of the magnetomotive force are shown in FIG. 13 by adding a suffix Q to the same reference numerals as in FIG. 15. That is, the dimensions are shown such as 2π·DutyQ, 2π·SlopeQ and KQ.

As above, the magnetomotive force of the rotor 14 actually includes harmonic components that make up useless components of magnetic flux, causing a problem of increasing the iron loss of the motor 10. In other words, the efficiency is highest without harmonic components, but decreases with increase in harmonic components.

The present invention has been made in view of the above-described circumstances and aims to solve the problem of providing a rotor of an electric rotating machine which can lower the iron loss due to harmonic components of the magnetomotive force generated by the rotor and thereby improve the efficiency.

### Means for Solving Problems

The inventor of the present application has conducted various investigations and analyses for lowering iron loss due to harmonic components of a magnetomotive force generated by a rotor (hereinafter, will be also referred to as [harmonic iron loss]), and found that the harmonic iron loss can be lowered by lowering the harmonic components of the magnetomotive force. Moreover, the inventor has further conducted investigations and analyses for determining which parts of the rotor exert influence on generation of the harmonic iron loss, and found that as a factor of exerting influence only on the harmonic components of the magnetomotive force, the influence of the surface shape of the rotor is largest. Based on the above findings, the inventor of the present application has earnestly conducted research focusing his attention on the waveform of the magnetomotive force generated by the rotor. As a result, the inventor has ascertained the following factors (1)-(3), thereby having completed the present invention.

(1) It is possible to eliminate any order harmonic component of the magnetomotive force by suitably setting a range (arc angle) within which magnetic flux is generated from the outer peripheral surface of the rotor.

(2) It is possible to eliminate any order harmonic component of the magnetomotive force by suitably setting the slope of the magnetic flux change in those areas on the surface of the rotor where the magnetic flux density changes rapidly.

(3) It is possible to eliminate any order harmonic component of the magnetomotive force by suitably setting the peak value of the magnetic flux in those areas on the surface of the rotor where the magnetic flux density changes rapidly.

That is, the first invention recited in claim 1, which has been made for solving the above-described problems, provides a rotor of an electric rotating machine. The rotor includes an annular rotor core and a plurality of permanent magnets embedded in the rotor core. A plurality of magnetic poles are formed in the vicinity of an outer periphery of the rotor core by the permanent magnets. The magnetic poles are arranged in a circumferential direction of the rotor core at predetermined intervals so that polarities thereof alternate between N and S in the circumferential direction. A waveform of a magnetomotive force generated by the rotor is comprised of a plurality of sections that respectively correspond to the magnetic poles. When viewed along an axial direction of the rotor core, the sections of the waveform either protrude radially outward from a 0 reference line, which is defined by an outer peripheral surface of the rotor core, or are recessed radially inward from the 0 reference line. Among the sections of the waveform, those sections which protrude radially outward are alternately arranged in the circumferential direction of the rotor core with those sections which are recessed radially inward. Each of the sections of the waveform includes two oblique lines, each of which extends from the 0 reference line obliquely with respect to a radial direction of the rotor core, and a connection line that connects the two oblique lines in the circumferential direction of the rotor core. Representing a circumferential width of the connection line by 2π·Duty, a circumferential width of the oblique lines by 2π·Slope, a radial height of the oblique lines by B, the order of a harmonic component of the magnetomotive force by n, and an amplitude of the nth harmonic component by Amp₁, then the following relationship is satisfied: Slope=k/n (here, k is an arbitrary natural number). The amplitude of the nth harmonic component is determined by the following Equation (1):

$${Amp}_{1} ( n ) = \frac{4 B}{n π} \cdot \frac{sin ( n π \cdot Slope )}{n π \cdot Slope} \cdot sin \{ n π ( Duty + Slope ) \} . \qquad ( 1 )$$

According to the invention recited in claim 1, it is possible to lower the amplitude Amp₁ of the nth harmonic component of the magnetomotive force to 0 by configuring each section of the waveform of the magnetomotive force generated by the rotor to satisfy the relationship of Slope=k/n. That is, since Slope=k/n is derived with sin (nπ·Slope) in Equation (1) being set to zero, the amplitude Amp₁ of the nth harmonic component of the magnetomotive force becomes 0 when the relationship of Slope=k/n is satisfied. Consequently, it is possible to eliminate any desired-order harmonic component from the magnetomotive force generated by the rotor. For example, if it is desired to eliminate the fifth harmonic component which involves the harmonic iron loss, then it is possible to make Amp₁ (5)=0 with n=5, thereby eliminating the fifth harmonic component.

Therefore, according to the present invention, it is possible to eliminate any order harmonic component of the magnetomotive force generated by the rotor, thereby reducing the harmonic iron loss to improve the efficiency.

The second invention recited in claim 2, which also has been made for solving the above-described problems, provides a rotor of an electric rotating machine. The rotor includes an annular rotor core and a plurality of permanent magnets embedded in the rotor core. A plurality of magnetic poles are formed in the vicinity of an outer periphery of the rotor core by the permanent magnets. The magnetic poles are arranged in a circumferential direction of the rotor core at predetermined intervals so that polarities thereof alternate between N and S in the circumferential direction. A waveform of a magnetomotive force generated by the rotor is comprised of a plurality of sections that respectively correspond to the magnetic poles. When viewed along an axial direction of the rotor core, the sections of the waveform either protrude radially outward from a 0 reference line, which is defined by an outer peripheral surface of the rotor core, or are recessed radially inward from the 0 reference line. Among the sections of the waveform, those sections which protrude radially outward are alternately arranged in the circumferential direction of the rotor core with those sections which are recessed radially inward. Each of the sections of the waveform includes two oblique lines, each of which extends from the 0 reference line obliquely with respect to a radial direction of the rotor core, and a connection line that connects the two oblique lines in the circumferential direction of the rotor core. Representing a circumferential width of the connection line by 2π·Duty, a circumferential width of the oblique lines by 2π·Slope, a radial height of the oblique lines by B, the order of a harmonic component of the magnetomotive force by n, and an amplitude of the nth harmonic component by Amp₁, then the following relationship is satisfied: Duty+Slope=k/n (here, k is an arbitrary natural number). The amplitude of the nth harmonic component being determined by the following Equation (1):

$${Amp}_{1} ( n ) = \frac{4 B}{n π} \cdot \frac{sin ( n π \cdot Slope )}{n π \cdot Slope} \cdot sin \{ n π ( Duty + Slope ) \} . \qquad ( 1 )$$

According to the invention recited in claim 2, it is possible to lower the amplitude Amp₁ of the nth harmonic component of the magnetomotive force to 0 by configuring each section of the waveform of the magnetomotive force generated by the rotor to satisfy the relationship of Duty+Slope=k/n. That is, since Duty+Slope=k/n is derived with sin {nπ·(Duty+Slope)} in Equation (1) being set to zero, the amplitude Amp₁ of the nth harmonic component of the magnetomotive force becomes 0 when the relationship of Duty+Slope=k/n is satisfied. Consequently, it is possible to eliminate any desired-order harmonic component from the magnetomotive force generated by the rotor. For example, if it is desired to eliminate the fifth harmonic component which involves the harmonic iron loss, then it is possible to make Amp₁ (5)=0 with n=5, thereby eliminating the fifth harmonic component.

Therefore, according to the present invention, it is possible to eliminate any order harmonic component of the magnetomotive force generated by the rotor, thereby reducing the harmonic iron loss to improve the efficiency.

The invention recited in claim 3 is characterized in that: the rotor core is comprised of a plurality of segments that respectively correspond to the magnetic poles; and in an outer peripheral surface of each segment of the rotor core, there are provided either a plurality of grooves that are recessed radially inward and extend in an axial direction of rotation or a plurality of protrusions that protrude radially outward and extend in the axial direction of rotation.

According to the invention recited in claim 3, the grooves or the protrusions provided in the outer peripheral surface of each segment of the rotor core become portions where magnetic flux density changes rapidly; therefore, it is possible to optimize the slope of magnetic flux change by suitably setting the shape, size and positions of the grooves or the protrusions. Consequently, it is possible to more effectively lower the harmonic iron loss.

The invention recited in claim 4 is characterized in that: in each segment of the rotor core, the grooves or the protrusions are provided within a circumferential range where the permanent magnets exist, and arranged at such positions that when viewed along the axial direction of the rotor core, they are symmetrical with respect to a circumferential centerline of the corresponding magnetic pole that is formed by the permanent magnets.

According to the invention recited in claim 4, each section of the waveform of the magnetomotive force generated by the rotor has a shape of being symmetrical with respect to the circumferential centerline of the connection line; therefore, the waveform of the magnetomotive force generated by the rotor can be made close to an ideal waveform that is advantageous to reduction of the harmonic iron loss.

The invention recited in claim 5 is characterized in that: in each segment of the rotor core, each of the grooves or the protrusions is formed at a given width from one outer end of the circumferential range, where the permanent magnets exist, toward the inside of the range.

According to the invention recited in claim 5, it is possible to provide, within the range (arc angle) where magnetic flux is generated from the outer peripheral surface of the rotor core segment, the grooves or the protrusions over a wide circumferential range.

The third invention recited in claim 6, which also has been made for solving the above-described problems, provides a rotor of an electric rotating machine. The rotor includes an annular rotor core and a plurality of permanent magnets embedded in the rotor core. A plurality of magnetic poles are formed in the vicinity of an outer periphery of the rotor core by the permanent magnets. The magnetic poles are arranged in a circumferential direction of the rotor core at predetermined intervals so that polarities thereof alternate between N and S in the circumferential direction. In an outer peripheral surface of the rotor core, there is provided, at a circumferential center of each of the magnetic poles, either a groove that is recessed radially inward and extends in an axial direction of rotation or a protrusion that protrudes radially outward and extends in the axial direction of rotation. A waveform of a magnetomotive force generated by the rotor is comprised of a plurality of sections that respectively correspond to the magnetic poles. When viewed along an axial direction of the rotor core, the sections of the waveform either protrude radially outward from a 0 reference line, which is defined by the outer peripheral surface of the rotor core, or are recessed radially inward from the 0 reference line. Among the sections of the waveform, those sections which protrude radially outward are alternately arranged in the circumferential direction of the rotor core with those sections which are recessed radially inward. Each of the sections of the waveform includes two first oblique lines, each of which extends from the 0 reference line obliquely with respect to a radial direction of the rotor core, and a first connection line that connects the first oblique lines in the circumferential direction of the rotor core. The first connection line includes two second oblique lines, each of which extends obliquely with respect to a radial direction of the rotor core, and a second connection line that connects the second oblique lines in the circumferential direction of the rotor core.

Representing a circumferential width of the first connection line by 2π·Duty₁, a circumferential width of the first oblique lines by 2π·Slope₁, a radial height of the first oblique lines by B₁, a circumferential width of the second connection line by 2π·Duty₂, a circumferential width of the second oblique lines by 2π·Slope₂, a radial height of the second oblique lines by B₂, the order of a harmonic component of the magnetomotive force by n, and an amplitude of the nth harmonic component by Amp₂, which is determined by the following Equation (2), then B2 satisfies the flowing Equation (3):

$$\begin{matrix}\begin{matrix}{Amp}_{2} ( n ) = \frac{4 {B}_{1}}{n π} \cdot \frac{sin ( n π \cdot {Slope}_{1} )}{n π \cdot {Slope}_{1}} \cdot sin \{ n π ( {Duty}_{1} + {Slope}_{1} ) \} + \frac{4 {B}_{2}}{n π} \cdot \frac{sin ( n π \cdot {Slope}_{2} )}{n π \cdot {Slope}_{2}} \cdot sin \{ n π ( {Duty}_{2} + {Slope}_{2} ) \} , & \end{matrix} & ( 2 ) \\ {B}_{2} = - \frac{{Slope}_{2}}{{Slope}_{1}} \cdot \frac{sin ( n π \cdot {Slope}_{1} )}{sin ( n π \cdot {Slope}_{2} )} \cdot \frac{sin \{ n π ( {Duty}_{1} + {Slope}_{1} ) \}}{sin \{ n π ( {Duty}_{2} + {Slope}_{2} ) \}} \cdot {B}_{1} . & ( 3 )\end{matrix}$$

According to the invention recited in claim 6, it is possible to lower the amplitude Amp₂ of the nth harmonic component of the magnetomotive force to 0 by configuring each section of the waveform of the magnetomotive force generated by the rotor to satisfy Equation (3). That is, since Equation (3) is derived by solving B2 with respect to B1 with Amp₂=0 in Equation (2), the amplitude Amp₂ of the nth harmonic component of the magnetomotive force becomes 0 when the relationship of Equation (3) is satisfied. Consequently, it is possible to eliminate any desired-order harmonic component from the magnetomotive force generated by the rotor. For example, if it is desired to eliminate the fifth harmonic component which involves the harmonic iron loss, then it is possible to make Amp₂ (5)=0 with n=5, thereby eliminating the fifth harmonic component.

Therefore, according to the present invention, it is possible to eliminate any order harmonic component of the magnetomotive force generated by the rotor, thereby reducing the harmonic iron loss to improve the efficiency.

### BRIEF DESCRIPTION OF THE DRAWINGS

FIG. 1 is a cross-sectional view taken along the axial direction of rotation, which shows the structure of an electric rotating machine according to a first embodiment of the present invention.

FIG. 2 is a cross-sectional view showing, of a rotor according to the first embodiment which is divided in its circumferential direction into a plurality of segments, two adjacent rotor core segments that respectively correspond to two magnetic poles.

FIG. 3 is an explanatory view giving a comparison in waveform of magnetomotive force between a rotor core according to the first embodiment and a conventional rotor core.

FIG. 4(a) is a schematic waveform chart showing in electrical angle the waveform of a magnetomotive force generated by the rotor according to the first embodiment; FIG. 4(b) is a view showing the amplitude of a harmonic component of the magnetomotive force for each order.

FIG. 5 is a cross-sectional view showing, of a rotor according to a second embodiment which is divided in its circumferential direction into a plurality of segments, a rotor core segment that corresponds to one magnetic pole.

FIG. 6(a) is a schematic waveform chart showing in electrical angle the waveform of a magnetomotive force generated by the rotor according to the second embodiment; FIG. 6(b) is a view showing the amplitude of a harmonic component of the magnetomotive force for each order.

FIG. 7 is a cross-sectional view showing, of a rotor according to a third embodiment which is divided in its circumferential direction into a plurality of segments, a rotor core segment that corresponds to one magnetic pole.

FIG. 8 is an explanatory view showing the dimension of each portion of the waveform of the magnetomotive force generated by the rotor according to the third embodiment.

FIG. 9 is a waveform chart showing the dimension of each portion of the waveform of the magnetomotive force generated by the rotor according to the third embodiment.

FIG. 10 is a cross-sectional view showing, of a rotor according to a modification of the third embodiment which is divided in its circumferential direction into a plurality of segments, a rotor core segment that corresponds to one magnetic pole.

FIG. 11 is a cross-sectional view taken along the axial direction of rotation, which shows the structure of a conventional electric rotating machine.

FIG. 12 is a cross-sectional view showing, of a rotor of the conventional electric rotating machine which is divided in its circumferential direction into a plurality of segments, two adjacent rotor core segments that respectively correspond to two magnetic poles.

FIG. 13 is an explanatory view showing the dimension of each portion of the waveform of the magnetomotive force generated by the rotor of the conventional electric rotating machine.

FIG. 14(a) is a schematic waveform chart showing in electrical angle the waveform of the magnetomotive force generated by the rotor of the conventional electric rotating machine; FIG. 14(b) is a view showing the amplitude of a harmonic component of the magnetomotive force for each order.

FIG. 15 is a waveform chart showing the dimension of each portion of the waveform of a magnetomotive force generated by a rotor.

### EMBODIMENTS FOR CARRYING OUT THE INVENTION

Hereinafter, embodiments for carrying out the present invention will be described with reference to the drawings.

### First Embodiment

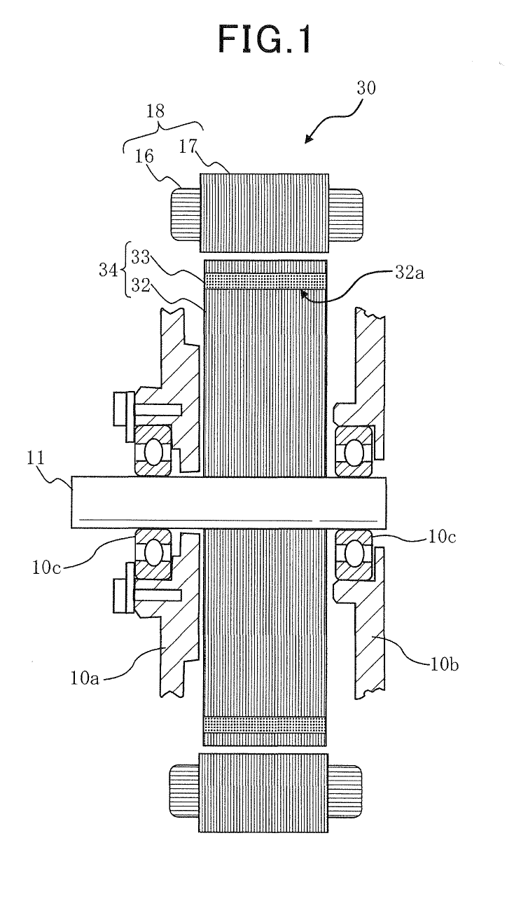

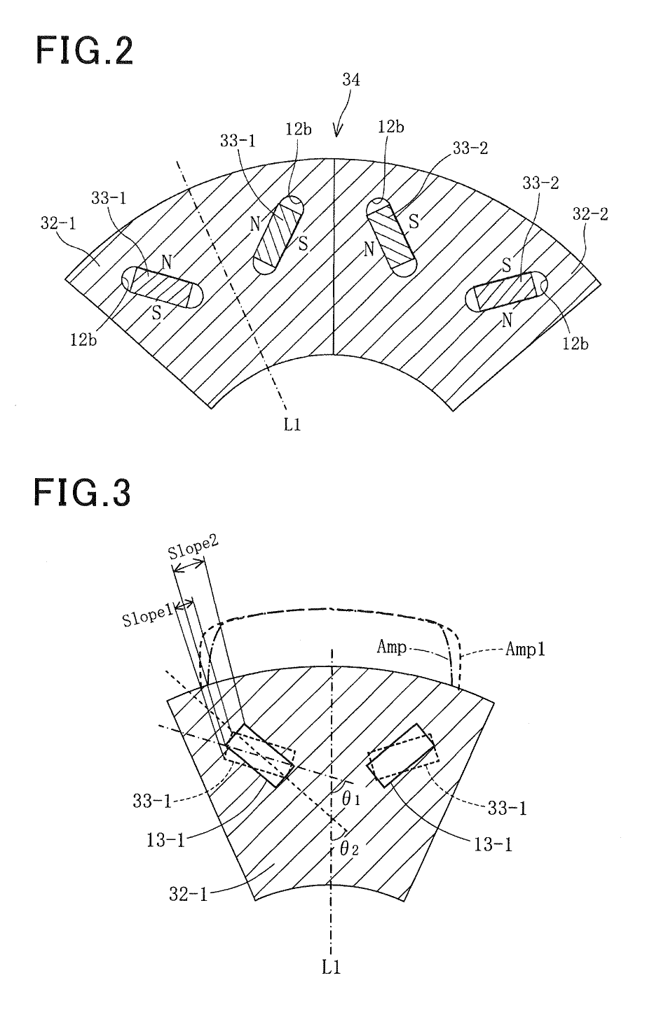

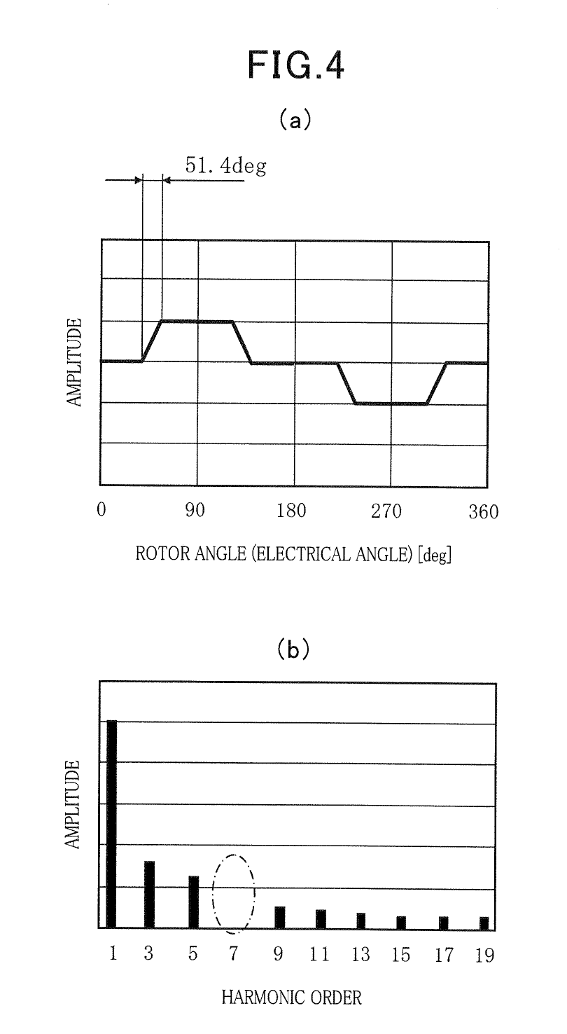

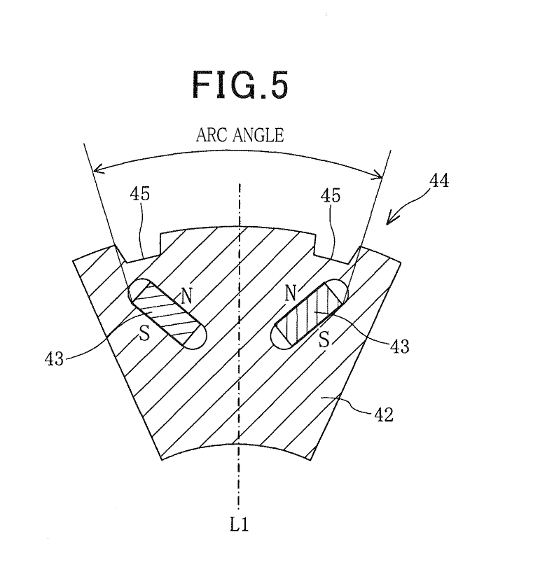

FIG. 1 is a cross-sectional view taken along the axial direction of rotation, which shows the structure of an electric rotating machine according to a first embodiment. FIG. 2 is a cross-sectional view showing, of a rotor according to the first embodiment which is divided in its circumferential direction into a plurality of segments, two adjacent rotor core segments that respectively correspond to two magnetic poles. FIG. 3 is an explanatory view giving a comparison in waveform of magnetomotive force between a rotor core according to the first embodiment and a conventional rotor core. FIG. 4(a) is a schematic waveform chart showing in electrical angle the waveform of a magnetomotive force generated by the rotor according to the first embodiment; FIG. 4(b) is a view showing the amplitude of a harmonic component for each order.

The electric rotating machine 30 of this embodiment is to be used, for example, as an automotive motor. As shown in FIG. 1, the electric rotating machine 30 includes a stator 18 working as an armature, the rotor 34 working as a field, and front and rear housings 10a and 10b that receive the stator 18 and the rotor 34 and are connected and fixed together by means of connecting bolts (not shown).

The stator 18 includes an annular stator core 17 and a three-phase stator coil 16. The stator core 17 has a plurality of slots (not shown) formed in its radially-inner peripheral surface along its circumferential direction. The stator coil 16 is wound on the stator core 17 and connected to an inverter (not shown) for electric power conversion. Moreover, the stator 18 is fixed by being sandwiched between the front and rear housings 10a and 10b and arranged on the radially outside of the rotor 34 with a predetermined clearance provided therebetween.

The rotor 34 is configured to rotate together with a rotating shaft 11 that is rotatably supported by the front and rear housings 10a and 10b via bearings 10c. The rotor 34 includes a rotor core 32 and a plurality of permanent magnets 33. The rotor core 32 is formed by laminating a plurality of annular steel sheets in the axial direction and fixed to an outer periphery of the rotating shaft 11. Moreover, in an outer peripheral side of the rotor core 32 facing a radially inner side of the stator 18, there are formed a plurality of through-holes 32a that penetrate the stator core 32 in the axial direction and are arranged in the circumferential direction at predetermined intervals. The permanent magnets 33 are respectively embedded in corresponding ones of the through-holes 32a of the rotor core 32. In the present embodiment, each pair of the permanent magnets 33 is arranged in shape of a Japanese character “ [symbol] ” to form a magnetic pole in the vicinity of the outer periphery of the rotor core 32. Moreover, a plurality of magnetic poles (in the present embodiment, 8 poles (N poles: 4, S poles: 4)), which are formed by the plurality of pairs of the permanent magnets 33 in the vicinity of the outer periphery of the rotor core 32, are arranged in the circumferential direction of the rotor core 32 at predetermined intervals so that the polarities thereof alternate between N and S in the circumferential direction.

As shown in FIG. 2, when viewed along the axial direction of the rotor core 32, in one rotor core segment 32-1 that corresponds to one magnetic pole, a pair of the permanent magnets 33-1 are symmetrically arranged (in the shape of “ [symbol] ”) with respective to a centerline L1 so as to be opposed to each other at predetermined inclination angles to the centerline L1; the centerline L1 radially extends through the center of the magnetic pole. Further, the pair of the permanent magnets 33-1 is arranged so as to be opposite in polarity to a pair of the permanent magnets 33-2 which is circumferentially adjacent to the pair of the permanent magnets 33-1. For example, the pair of the permanent magnets 33-1 is arranged so as to be N on the radially outer side and S on the radially inner side; the adjacent pair of the permanent magnets 33-2 is arranged so as to be S on the radially outer side and N on the radially inner side.

The rotor 34 of the present embodiment has a range (arc angle), within which magnetic flux is generated from the outer peripheral surface of the rotor 34, optimally set so as to reduce iron loss due to harmonic components of the magnetomotive force generated by the rotor 34. That is, the waveform of the magnetomotive force generated by the rotor 34 of the present embodiment is comprised of a plurality of sections that respectively correspond to the plurality of the magnetic poles (or the plurality of the rotor core segments). When viewed along the axial direction of the rotor core 32, those sections either protrude radially outward from a 0 reference line, which is defined by the outer peripheral surface of the rotor core 32, or are recessed radially inward from the 0 reference line. Further, among the above sections of the waveform, those sections which protrude radially outward are alternately arranged in the circumferential direction of the rotor core 32 with those sections which are recessed radially inward. Furthermore, each of the sections of the waveform includes two oblique lines and a connection line. Each of the oblique lines extends from the 0 reference line obliquely with respect to a radial direction of the rotor core 32. The connection line connects the two oblique lines in the circumferential direction of the rotor core 32.

Moreover, representing the circumferential width of the connection line by 2π·Duty, the circumferential width of the oblique lines by 2π·Slope, the radial height of the oblique lines by B, the order of a harmonic component of the magnetomotive force generated by the rotor 34 by n, and the amplitude of the nth harmonic component by Amp₁, then the following relationship is satisfied: Slope=k/n (here, k is an arbitrary natural number). The amplitude of the nth harmonic component is determined by the following Equation (1):

$${Amp}_{1} ( n ) = \frac{4 B}{n π} \cdot \frac{sin ( n π \cdot Slope )}{n π \cdot Slope} \cdot sin \{ n π ( Duty + Slope ) \} . \qquad ( 1 )$$

In this case, for example, n=7 in Equation (1) so as to eliminate the seventh harmonic component involving harmonic iron loss.

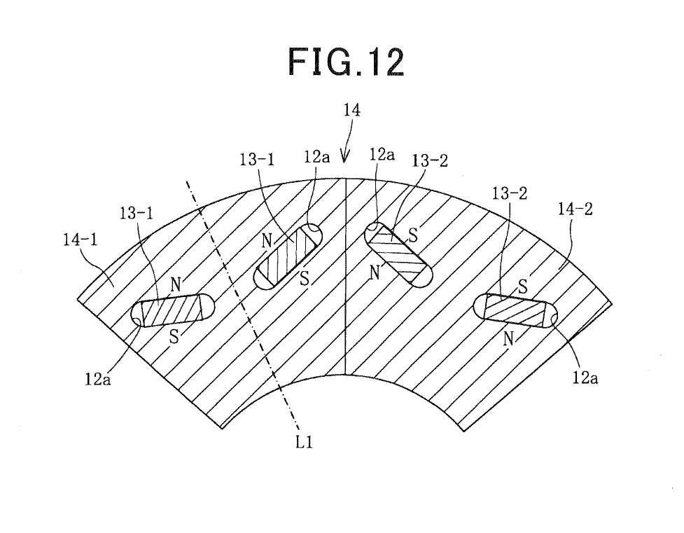

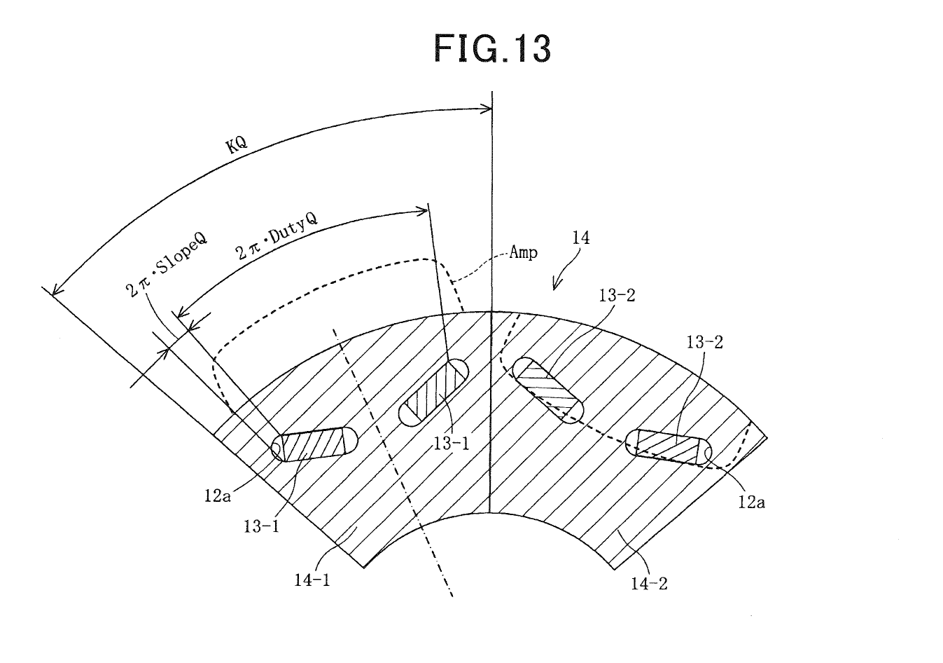

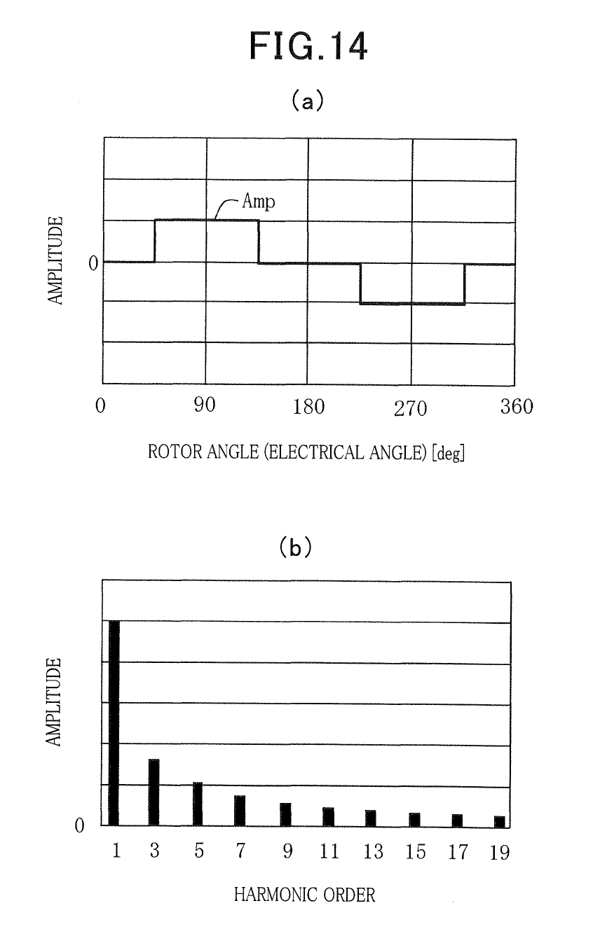

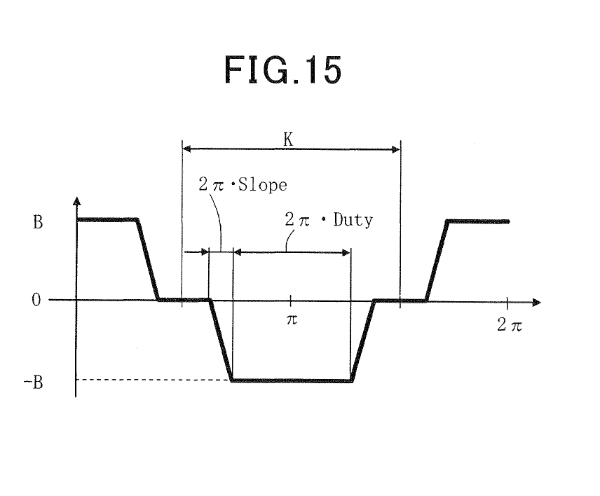

Specifically, Slope is set to 51.4 degrees (electrical angle) by adjusting the arrangement state of the pair of the permanent magnets 33 in each rotor core segment, so as to eliminate the seventh component involving harmonic iron loss. That is, as shown in FIG. 3, in the conventional rotor 14 (see FIG. 12), the pair of the permanent magnets 13 are arranged so that the longitudinal axes thereof are oblique at an angle θ1 with respect to the centerline L1; in the present embodiment, the pair of the permanent magnets 33 are arranged so that the longitudinal axes thereof are oblique with respect to the centerline L1 at an angle θ2 that is smaller than angle θ1. Consequently, Slope1 of the waveform of the magnetomotive force is enlarged to Slope2.

In the present embodiment, by setting Slope to 51.4 degrees (electrical angle), the waveform of the magnetomotive force generated by the rotor 34 becomes as shown in FIG. 4(a). Consequently, as shown in FIG. 4(b), it becomes possible to eliminate the seventh harmonic component. This is because any harmonic component whose order is an integer multiple of 7 is eliminated since Slope=k/7. Accordingly, the fourteenth harmonic component could also be eliminated; however, the fourteenth harmonic component does not exist originally and thus the elimination thereof does not make a physical sense.

As above, the rotor 34 of the present embodiment can lower the amplitude Amp₁ of the nth harmonic component of the magnetomotive force to 0 by being configured so that each section of the waveform of the magnetomotive force generated by the rotor 34 satisfies the relationship of Slope=k/n. That is, since any order harmonic component of the magnetomotive force can be eliminated, it is possible to eliminate the harmonic components of those orders which involve harmonic iron loss, thereby reducing the harmonic iron loss to improve the efficiency.

### Second Embodiment

FIG. 5 is a cross-sectional view showing, of a rotor according to a second embodiment which is divided in its circumferential direction into a plurality of segments, a rotor core segment that corresponds to one magnetic pole.

The rotor 44 of this embodiment differs from the rotor 34 of the first embodiment only in that in the outer peripheral surface of each rotor core segment, there are formed two grooves 45 that are recessed radially inward and penetrate the rotor core segment in the axial direction of rotation. Accordingly, detailed explanations of members and configurations in common with the first embodiment will be omitted, and the differences will be mainly explained. In addition, in the rotor core 42 of the present embodiment, as in the rotor core 31 of the first embodiment, within the range of one magnetic pole, a pair of permanent magnets 43 are symmetrically arranged (in the shape of “ [symbol] ”) with respective to a centerline L1 so as to be opposed to each other at predetermined inclination angles to the centerline L1; the centerline L1 extends in a radial direction of the rotor core 32 through the center of the magnetic pole.

The two grooves 45 are provided within a circumferential range of the rotor core segment where the permanent magnets 43 exist, and symmetrically arranged with respect to the centerline L1. Each of the two grooves 45 is formed, within the circumferential range for one magnetic pole where the permanent magnets 43 exist, at a given width from one outer end of the range toward the inside of the range.

The rotor 44 of the present embodiment has a range (arc angle), within which magnetic flux is generated from the outer peripheral surface of the rotor 44, optimally set so as to reduce iron loss due to harmonic components of the magnetomotive force generated by the rotor 44. That is, the waveform of the magnetomotive force generated by the rotor 44 of the present embodiment is comprised of a plurality of sections that respectively correspond to the plurality of the magnetic poles (or the plurality of the rotor core segments). When viewed along the axial direction of the rotor core 42, those sections either protrude radially outward from a 0 reference line, which is defined by the outer peripheral surface of the rotor core 42, or are recessed radially inward from the 0 reference line. Further, among the above sections of the waveform, those sections which protrude radially outward are alternately arranged in the circumferential direction of the rotor core 42 with those sections which are recessed radially inward. Furthermore, each of the sections of the waveform includes two oblique lines and a connection line. Each of the oblique lines extends from the 0 reference line obliquely with respect to a radial direction of the rotor core 42. The connection line connects the two oblique lines in the circumferential direction of the rotor core 42.

Moreover, representing the circumferential width of the connection line by 2π·Duty, the circumferential width of the oblique lines by 2π·Slope, the radial height of the oblique lines by B, the order of a harmonic component of the magnetomotive force generated by the rotor 44 by n, and the amplitude of the nth harmonic component by Amp₁, then the following relationship is satisfied: Duty+Slope=k/n (here, k is an arbitrary natural number). The amplitude of the nth harmonic component is determined by the following Equation (1):

$${Amp}_{1} ( n ) = \frac{4 B}{n π} \cdot \frac{sin ( n π \cdot Slope )}{n π \cdot Slope} \cdot sin \{ n π ( Duty + Slope ) \} . \qquad ( 1 )$$

Specifically, the arc angle is set to 120 degrees (electrical angle) by adjusting the shape of the outer peripheral surface of the rotor core 42, so as to eliminate the third component involving harmonic iron loss. That is, the arc angle is set to 120 degrees (electrical angle) by forming the two grooves 45 in the outer peripheral surface of the rotor core 42 as above. In addition, those areas where the two grooves 45 are provided are areas where magnetic flux density changes rapidly; the slope of the magnetic flux change in those areas can be adjusted by varying the depth of the grooves 45.

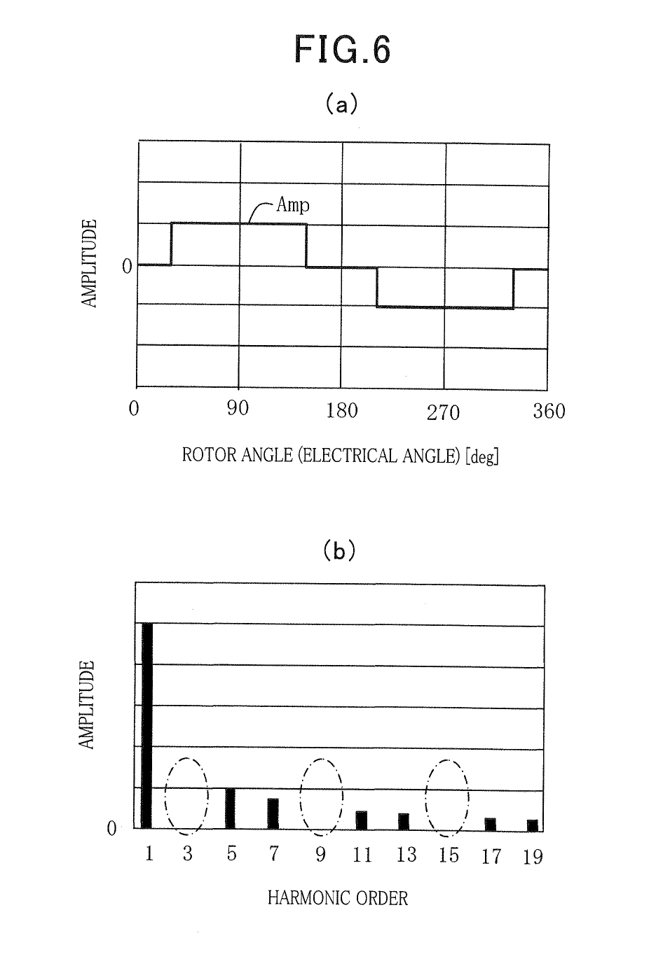

In the present embodiment, by setting the arc angle to 120 degrees (electrical angle), the waveform of the magnetomotive force becomes as shown in FIG. 6(a). Consequently, as shown in FIG. 6(b), it becomes possible to eliminate the third, the ninth and the fifteenth harmonic components. This is because any harmonic component whose order is an integer multiple of 3 is eliminated since Duty+Slope=⅓. Accordingly, the sixth and the twelfth harmonic components could also be eliminated; however, those harmonic components do not exist originally and thus the elimination thereof does not make a physical sense.

As above, the rotor 44 of the present embodiment can lower the amplitude Amp₁ of the nth harmonic component of the magnetomotive force to 0 by being configured so that each section of the waveform of the magnetomotive force generated by the rotor 44 satisfies the relationship of Duty+Slope=k/n. That is, since any order harmonic component of the magnetomotive force can be eliminated, it is possible to eliminate the harmonic components of those orders which involve harmonic iron loss, thereby reducing the harmonic iron loss to improve the efficiency.

Moreover, in the present embodiment, the two grooves 45 formed in the outer peripheral surface of each rotor core segment become portions where magnetic flux density changes rapidly; therefore, it is possible to optimize the slope of magnetic flux change by suitably setting the shape, size and positions of the grooves 45.

Further, the two grooves 45 are provided within the circumferential range where the permanent magnets 43 of the rotor core segment exist, and symmetrically arranged with respect to the circumferential centerline L1 of the magnetic pole that is formed by the permanent magnets 43; consequently, the waveform of the magnetomotive force generated by the rotor core segment has a shape of being symmetrical with respect to the centerline L1 that passes through the circumferential center of the connection line, thereby approaching an ideal waveform that is advantageous to reduction of harmonic iron loss.

Furthermore, each of the two grooves 45 is formed, within the circumferential range of the rotor core segment where the permanent magnets 43 exist, at the given width from one outer end of the range toward the inside of the range; therefore, it is possible to provide, within the range (arc angle) where magnetic flux is generated from the outer peripheral surface of the rotor core segment, the two grooves 45 over a wide circumferential range.

In addition, in the present embodiment, in the outer peripheral surface of each rotor core segment, there are provided the two grooves 45 that are recessed radially inward and penetrate the rotor core segment in the axial direction of rotation; however, instead of the two grooves 45, it is also possible to provide two protrusions that protrude radially outward and penetrate in the axial direction of rotation.

### Third Embodiment

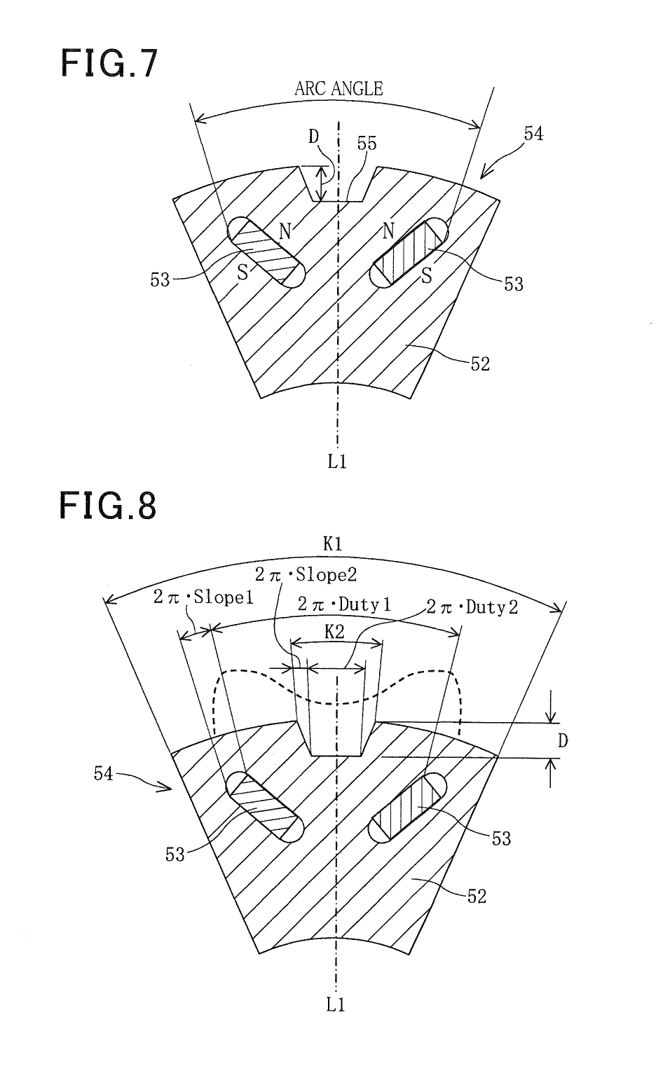

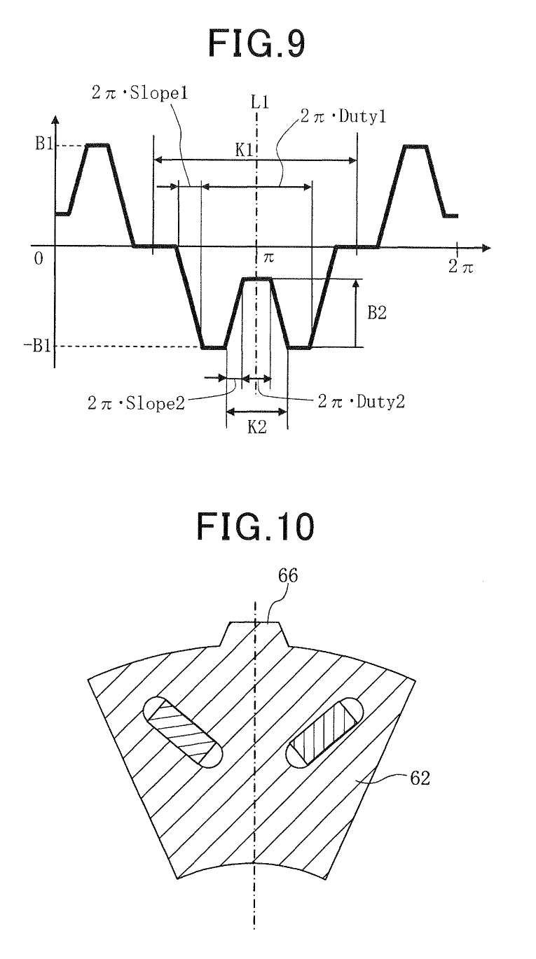

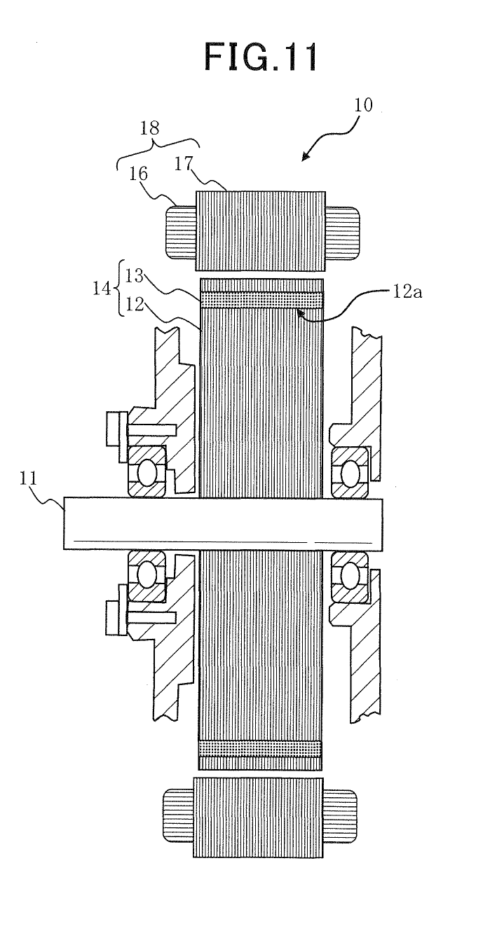

FIG. 7 is a cross-sectional view showing, of a rotor according to a third embodiment which is divided in its circumferential direction into a plurality of segments, a rotor core segment that corresponds to one magnetic pole. FIG. 8 is an explanatory view showing the dimension of each portion of the waveform of the magnetomotive force generated by the rotor according to the third embodiment. FIG. 9 is a waveform chart showing the dimension of each portion of the waveform of the magnetomotive force generated by the rotor according to the third embodiment.

The rotor 54 of this embodiment differs from the rotor 34 of the first embodiment only in that in the outer peripheral surface of each rotor core segment, there is formed, at the circumferential center of the magnetic pole formed by the permanent magnets 53, a groove 55 that is recessed radially inward and extends in the axial direction of rotation. Accordingly, detailed explanations of members and configurations in common with the first embodiment will be omitted, and the differences will be mainly explained. In addition, in the rotor core 52 of the present embodiment, as in the rotor core 32 of the first embodiment, within the range of one magnetic pole, a pair of permanent magnets 53 are symmetrically arranged (in the shape of “ [symbol] ”) with respective to a centerline L1 so as to be opposed to each other at predetermined inclination angles to the centerline L1; the centerline L1 extends in a radial direction of the rotor core 52 through the center of the magnetic pole.

In the rotor 54 of the present embodiment, to reduce iron loss due to harmonic components of the magnetomotive force generated by the rotor 54, in the outer peripheral surface of each rotor core segment, there is formed, at the circumferential center of the magnetic pole formed by the permanent magnets 53 (the center of the arc angle), the groove 55 that has a given depth D.

That is, as shown in FIGS. 8 and 9, the waveform of the magnetomotive force generated by the rotor 54 of the present embodiment is comprised of a plurality of sections that respectively correspond to the plurality of the magnetic poles (or the plurality of the rotor core segments). When viewed along the axial direction of the rotor core 52, those sections either protrude radially outward from a 0 reference line, which is defined by the outer peripheral surface of the rotor core 52, or are recessed radially inward from the 0 reference line. Further, among the above sections of the waveform, those sections which protrude radially outward are alternately arranged in the circumferential direction of the rotor core 52 with those sections which are recessed radially inward. Furthermore, each of the sections of the waveform includes two first oblique lines and a first connection line. Each of the first oblique lines extends from the 0 reference line obliquely with respect to a radial direction of the rotor core 52. The first connection line connects the two first oblique lines in the circumferential direction of the rotor core 52. Further, the first connection line includes two second oblique lines, each of which extends obliquely with respect to a radial direction of the rotor core 52, and a second connection line that connects the two second oblique lines in the circumferential direction of the rotor core 52.

Moreover, as shown in FIG. 9, representing the circumferential width of the first connection line by 2π·Duty₁, the circumferential width of the first oblique lines by 2π·Slope₁, the radial height of the first oblique lines by B₁, the circumferential width of the second connection line by 2π·Duty₂, the circumferential width of the second oblique lines by 2π·Slope₂, the radial height of the second oblique lines by B₂, the order of a harmonic component of the magnetomotive force generated by the rotor 54 by n, and the amplitude of the nth harmonic component by Amp₂, which is determined by the following Equation (2), then B2 satisfies the flowing Equation (3):

$$\begin{matrix}\begin{matrix}{Amp}_{2} ( n ) = \frac{4 {B}_{1}}{n π} \cdot \frac{sin ( n π \cdot {Slope}_{1} )}{n π \cdot {Slope}_{1}} \cdot sin \{ n π ( {Duty}_{1} + {Slope}_{1} ) \} + \frac{4 {B}_{2}}{n π} \cdot \frac{sin ( n π \cdot {Slope}_{2} )}{n π \cdot {Slope}_{2}} \cdot sin \{ n π ( {Duty}_{2} + {Slope}_{2} ) \} , & \end{matrix} & ( 2 ) \\ {B}_{2} = - \frac{{Slope}_{2}}{{Slope}_{1}} \cdot \frac{sin ( n π \cdot {Slope}_{1} )}{sin ( n π \cdot {Slope}_{2} )} \cdot \frac{sin \{ n π ( {Duty}_{1} + {Slope}_{1} ) \}}{sin \{ n π ( {Duty}_{2} + {Slope}_{2} ) \}} \cdot {B}_{1} . & ( 3 )\end{matrix}$$

In the present embodiment, the groove 55 formed in the outer peripheral surface of each rotor core segment has the given depth D set to satisfy Equation (3). In addition, in forming the groove 55 in the outer peripheral surface of the rotor core segment, if the depth D of the groove 55 is set large, then the slope of Slope2 becomes steep; if the depth D of the groove 55 is set small, then the slope of Slope2 becomes gentle. Consequently, when the relationship of Equation (3) is satisfied, it is possible to lower the amplitude Amp₂ of the nth harmonic component of the magnetomotive force generated by the rotor 54 to 0. That is, it is possible to any order harmonic component of the magnetomotive force.

Accordingly, in the rotor 54 of the present embodiment, since any order harmonic component of the magnetomotive force generated by the rotor 54 can be eliminated, it is possible to eliminate the harmonic components of those orders which involve harmonic iron loss, thereby reducing the harmonic iron loss to improve the efficiency.

In addition, in the present embodiment, in the outer peripheral surface of each rotor core segment, there is provided the groove 55 that is recessed radially inward and penetrates the rotor core segment in the axial direction of rotation. However, instead of the groove 55, as in a rotor core 62 shown in FIG. 10, it is also possible to provide, on the outer peripheral surface of each rotor core segment, a protrusion 66 that protrudes radially outward and penetrates in the axial direction of rotation.

Moreover, in the above first to third embodiments, in each rotor core segment which corresponds to one magnetic pole, there are arranged a pair of the permanent magnets. However, with a configuration of arranging only one permanent magnet, it is also possible to achieve the same advantageous effects as the above embodiments.

### DESCRIPTION OF CHARACTERS

10, 30: Electric rotating machine; 11: Rotating shaft; 12, 12-1, 12-2, 32-1, 32-2, 42, 52, 62: Rotor core; 12a, 32a: Through-hole; 13, 33, 33-1, 33-2: Permanent magnet; 14, 34, 44, 54: Rotor; 16: Stator coil; 17: Stator core; 18: Stator; 45, 55: Groove; 66: Protrusion.

1. A rotor of an electric rotating machine, the rotor comprising an annular rotor core and a plurality of permanent magnets embedded in the rotor core,
wherein
a plurality of magnetic poles are formed in the vicinity of an outer periphery of the rotor core by the permanent magnets,
the magnetic poles are arranged in a circumferential direction of the rotor core at predetermined intervals so that polarities thereof alternate between N and S in the circumferential direction,
a waveform of a magnetomotive force generated by the rotor is comprised of a plurality of sections that respectively correspond to the magnetic poles,
when viewed along an axial direction of the rotor core, the sections of the waveform either protrude radially outward from a 0 reference line, which is defined by an outer peripheral surface of the rotor core, or are recessed radially inward from the 0 reference line,
among the sections of the waveform, those sections which protrude radially outward are alternately arranged in the circumferential direction of the rotor core with those sections which are recessed radially inward,
each of the sections of the waveform includes two oblique lines, each of which extends from the 0 reference line obliquely with respect to a radial direction of the rotor core, and a connection line that connects the two oblique lines in the circumferential direction of the rotor core, and
representing a circumferential width of the connection line by 2π·Duty, a circumferential width of the oblique lines by 2π·Slope, a radial height of the oblique lines by B, the order of a harmonic component of the magnetomotive force by n, and an amplitude of the nth harmonic component by Amp₁, then the following relationship is satisfied: Slope=k/n (here, k is an arbitrary natural number),
the amplitude of the nth harmonic component being determined by the following Equation (1):
$${Amp}_{1} ( n ) = \frac{4 B}{n π} \cdot \frac{sin ( n π \cdot Slope )}{n π \cdot Slope} \cdot sin \{ n π ( Duty + Slope ) \} . \qquad ( 1 )$$

2. A rotor of an electric rotating machine, the rotor comprising an annular rotor core and a plurality of permanent magnets embedded in the rotor core,
wherein
a plurality of magnetic poles are formed in the vicinity of an outer periphery of the rotor core by the permanent magnets,
the magnetic poles are arranged in a circumferential direction of the rotor core at predetermined intervals so that polarities thereof alternate between N and S in the circumferential direction,
a waveform of a magnetomotive force generated by the rotor is comprised of a plurality of sections that respectively correspond to the magnetic poles,
when viewed along an axial direction of the rotor core, the sections of the waveform either protrude radially outward from a 0 reference line, which is defined by an outer peripheral surface of the rotor core, or are recessed radially inward from the 0 reference line,
among the sections of the waveform, those sections which protrude radially outward are alternately arranged in the circumferential direction of the rotor core with those sections which are recessed radially inward,
each of the sections of the waveform includes two oblique lines, each of which extends from the 0 reference line obliquely with respect to a radial direction of the rotor core, and a connection line that connects the two oblique lines in the circumferential direction of the rotor core, and
representing a circumferential width of the connection line by 2π·Duty, a circumferential width of the oblique lines by 2π·Slope, a radial height of the oblique lines by B, the order of a harmonic component of the magnetomotive force by n, and an amplitude of the nth harmonic component by Amp₁, then the following relationship is satisfied: Duty+Slope=k/n (here, k is an arbitrary natural number),
the amplitude of the nth harmonic component being determined by the following Equation (1):
$${Amp}_{1} ( n ) = \frac{4 B}{n π} \cdot \frac{sin ( n π \cdot Slope )}{n π \cdot Slope} \cdot sin \{ n π ( Duty + Slope ) \} . \qquad ( 1 )$$

3. The rotor of the electric rotating machine as set forth in claim 1, wherein the rotor core is comprised of a plurality of segments that respectively correspond to the magnetic poles, and
in an outer peripheral surface of each segment of the rotor core, there are provided either a plurality of grooves that are recessed radially inward and extend in an axial direction of rotation or a plurality of protrusions that protrude radially outward and extend in the axial direction of rotation.

4. The rotor of the electric rotating machine as set forth in claim 3, wherein in each segment of the rotor core, the grooves or the protrusions are provided within a circumferential range where the permanent magnets exist, and arranged at such positions that when viewed along the axial direction of the rotor core, they are symmetrical with respect to a circumferential centerline of the corresponding magnetic pole that is formed by the permanent magnets.

5. The rotor of the electric rotating machine as set forth in claim 4, wherein in each segment of the rotor core, each of the grooves or the protrusions is formed at a given width from one outer end of the circumferential range, where the permanent magnets exist, toward the inside of the range.

6. A rotor of an electric rotating machine, the rotor comprising an annular rotor core and a plurality of permanent magnets embedded in the rotor core,
wherein
a plurality of magnetic poles are formed in the vicinity of an outer periphery of the rotor core by the permanent magnets,
the magnetic poles are arranged in a circumferential direction of the rotor core at predetermined intervals so that polarities thereof alternate between N and S in the circumferential direction,
in an outer peripheral surface of the rotor core, there is provided, at a circumferential center of each of the magnetic poles, either a groove that is recessed radially inward and extends in an axial direction of rotation or a protrusion that protrudes radially outward and extends in the axial direction of rotation,
a waveform of a magnetomotive force generated by the rotor is comprised of a plurality of sections that respectively correspond to the magnetic poles,
when viewed along an axial direction of the rotor core, the sections of the waveform either protrude radially outward from a 0 reference line, which is defined by the outer peripheral surface of the rotor core, or are recessed radially inward from the 0 reference line,
among the sections of the waveform, those sections which protrude radially outward are alternately arranged in the circumferential direction of the rotor core with those sections which are recessed radially inward,
each of the sections of the waveform includes two first oblique lines, each of which extends from the 0 reference line obliquely with respect to a radial direction of the rotor core, and a first connection line that connects the first oblique lines in the circumferential direction of the rotor core,
the first connection line includes two second oblique lines, each of which extends obliquely with respect to a radial direction of the rotor core, and a second connection line that connects the second oblique lines in the circumferential direction of the rotor core, and
representing a circumferential width of the first connection line by 2π·Duty₁, a circumferential width of the first oblique lines by 2π·Slope₁, a radial height of the first oblique lines by B₁, a circumferential width of the second connection line by 2π·Duty₂, a circumferential width of the second oblique lines by 2π·Slope₂, a radial height of the second oblique lines by B₂, the order of a harmonic component of the magnetomotive force by n, and an amplitude of the nth harmonic component by Amp₂, which is determined by the following Equation (2), then B2 satisfies the flowing Equation (3):
$$\begin{matrix}\begin{matrix}{Amp}_{2} ( n ) = \frac{4 {B}_{1}}{n π} \cdot \frac{sin ( n π \cdot {Slope}_{1} )}{n π \cdot {Slope}_{1}} \cdot sin \{ n π ( {Duty}_{1} + {Slope}_{1} ) \} + \frac{4 {B}_{2}}{n π} \cdot \frac{sin ( n π \cdot {Slope}_{2} )}{n π \cdot {Slope}_{2}} \cdot sin \{ n π ( {Duty}_{2} + {Slope}_{2} ) \} , & \end{matrix} & ( 2 ) \\ {B}_{2} = - \frac{{Slope}_{2}}{{Slope}_{1}} \cdot \frac{sin ( n π \cdot {Slope}_{1} )}{sin ( n π \cdot {Slope}_{2} )} \cdot \frac{sin \{ n π ( {Duty}_{1} + {Slope}_{1} ) \}}{sin \{ n π ( {Duty}_{2} + {Slope}_{2} ) \}} \cdot {B}_{1} . & ( 3 )\end{matrix}$$

7. The rotor of the electric rotating machine as set forth in claim 2, wherein the rotor core is comprised of a plurality of segments that respectively correspond to the magnetic poles, and
in an outer peripheral surface of each segment of the rotor core, there are provided either a plurality of grooves that are recessed radially inward and extend in an axial direction of rotation or a plurality of protrusions that protrude radially outward and extend in the axial direction of rotation.

8. The rotor of the electric rotating machine as set forth in claim 7, wherein in each segment of the rotor core, the grooves or the protrusions are provided within a circumferential range where the permanent magnets exist, and arranged at such positions that when viewed along the axial direction of the rotor core, they are symmetrical with respect to a circumferential centerline of the corresponding magnetic pole that is formed by the permanent magnets.

9. The rotor of the electric rotating machine as set forth in claim 8, wherein in each segment of the rotor core, each of the grooves or the protrusions is formed at a given width from one outer end of the circumferential range, where the permanent magnets exist, toward the inside of the range.
